(19) United States
(12) Patent Application Publication
(10) Pub. No.: US 2004/0145236 A1
(43) Pub. Date: Jul. 29, 2004

(54) Wheel cover fixture for different sized wheels

(75) Inventor: Ming-Fang Wang, Tainan Hsien (TW)

Correspondence Address: BACON & THOMAS, PLLC, 625 SLATERS LANE, FOURTH FLOOR, ALEXANDRIA, VA, 22314

(73) Assignee: Kuan Hsings Enterprise Corp., Tainan Hsien (TW)

(21) Appl. No.: 10/350,047

(22) Filed: Jan. 24, 2003

(51) Int. Cl. B60B 7/10

(52) U.S. Cl. 301/37.101; 301/37.33

(57) ABSTRACT

In the present invention, a first set of latch members and a second set of latch members are disposed on a wheel cover; wherein the first set of latch members encloses a first circular area with a first diameter D, the second set of latch members encloses a second circular area with a second diameter d, and the first diameter D is larger than the second diameter d, such that the wheel cover uses different sets of latch members to enclose areas of different diameters and fits the installation of different sized wheels.

### BACKGROUND OF THE INVENTION

1. Field of the Invention

This invention relates to a wheel cover fixture for different sized wheels, more particularly to a wheel cover fixture having a simple structure that can fit different sizes of steel wheels.

2. Description of the Related Art

The use of wheel cover of vehicles is very popular. In FIG. 1, a traditional wheel 1 cover is basically comprised of a circular disc; a plurality of engraved holes in special shapes disposed on the circular disc; a plurality of latch members equidistantly disposed on the backside of the wheel cover, each latch member integrally formed on the backside of the wheel cover, and each latch member at its end has a groove, such that the grooves of the latch members define an area for surrounding and supporting a steel ring, and the external periphery of the area defined by the latch members and propped by the steel ring is embedded into the steel wheel. Such area defined by the latch members can fit different sizes of steel wheels. Since regular vehicles have wheels in the size of 13 inches, 14 inches, or 15 inches. Even the engraved holes on the surface of the wheel cover is the same, it still requires 3 sets of molds for manufacturing three different sizes of wheel covers to fit the different sizes of the wheels, which makes the manufacturing cost very high, and such cost is definitely a burden to consumers.

### SUMMARY OF THE INVENTION

The objective of this invention is to provide an improved wheel cover fixture structure for different wheel sized wheels, which comprises a circular disc disposed on the wheel cover having a plurality engraved holes in special shapes, and a latch member disposed on the backside of the wheel cover; said latch member comprises a first set of latch members and a second set of latch members; wherein the first set of latch members encloses a circular area of a first diameter D, and the second set of latch members encloses a circular area of a second diameter d, and the first diameter D is larger than the second diameter d, such that the wheel cover makes use of different sets of latch members to enclose areas of different diameters and fit the installation of different sized wheels.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is an illustrative diagram of the backside of the wheel cover structure in accordance with a preferred embodiment of the present invention.

FIG. 2 is an illustrative diagram of the latching status (I) in accordance with a preferred embodiment of the present invention.

FIG. 3 is an illustrative diagram of the latching status (II) in accordance with a preferred embodiment of the present invention.

### DETAILED DESCRIPTION OF THE PREFERRED EMBODIMENTS

In the detailed description of the preferred embodiments, it should be noted that like elements are indicated by the same reference numerals throughout the disclosure.

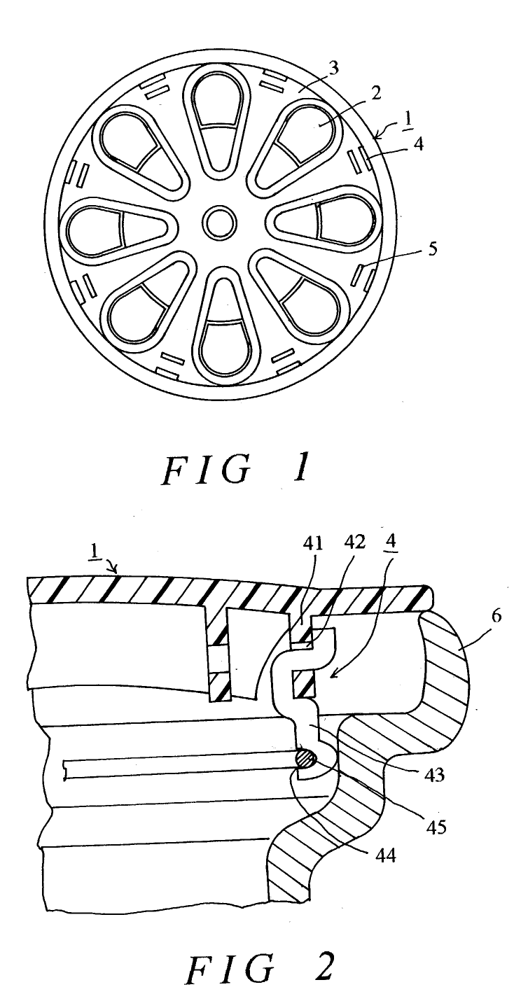

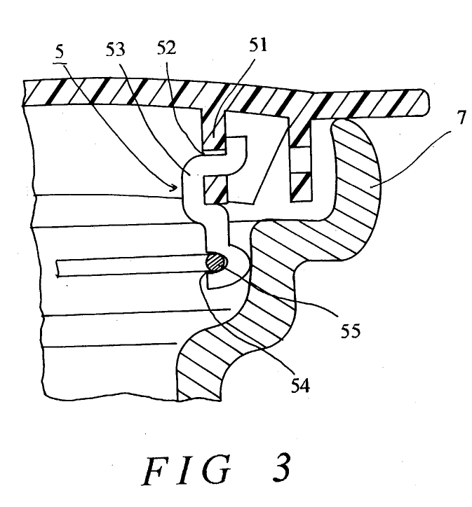

Please refer to FIG. 1 for a preferred embodiment of the present invention, which comprises a wheel cover 1 with a circular disc having a plurality of engraved holes 2 on the circular disc; a first set of latch members 4 and a second set of latch members 5 disposed on the backside 3 of the wheel cover; wherein the first set of latch members 4 encloses a circular area of a first diameter D; the second set of latch members 5 encloses a circular area of a second diameter D; the first diameter D is larger than the second diameter d; and the first set of latch members 4 and the second set of latch members 5 have a plurality of fixed bases 41, 51 equidistantly disposed on the backside of each wheel cover 1 respectively; referring to FIG. 2, each fixed base 41 of the first set of latch members 4 comprises a latch hole 42 for latching a latch member 53, and each latch member 43 at its ends has a groove 54, and the grooves 54 of each latch member 53 enclose a steel ring 55 to provide an area of said first diameter D; referring to FIG. 3, each fixed base 51 of the second set of latch members 5 comprises a latch hole 52 for latching a latch member 53, and each latch member 53 at its ends has a groove 54, and the grooves 54 of each latch member 53 enclose a steel ring 55 to provide an area of said second diameter d.

Please refer to FIG. 2; when the wheel cover 1 is used for a larger steel wheel 6 (such as 14 inches in diameter), each latch member 43 is installed into a latch hole 42 of each fixed base 41 of the first set of latch members 4, and the groove 44 at the ends of each latch member 43 enclose an area for surrounding a steel ring 45 and provide an area of the first diameter D for installing the steel wheel 6.

Please refer to FIG. 3; when the wheel cover 1 is used for a smaller steel wheel 7 (such as 13 inches in diameter), each latch member 53 is installed into a latch hole 52 of each fixed base 51 of the second set of latch members 5, and the groove 54 at the ends of each latch member 53 enclose an area for surrounding a steel ring 55 and provide an area of the second diameter d for installing the steel wheel 7.

Each latch member 43 of the first set of latch members 4, and each latch member 53 and steel ring 55 of the second set of latch members 53 can be shared. Therefore, it only needs one set of latch member 43 and steel ring 45 or latch members 53 and steel ring 55.

In the design, the two close sizes of the first set of latch members 4 and the second set of latch members 5 are set on the same wheel covert. For example, a wheel cover 1 can fit a steel wheel of 13 inches or 14 inches, or the same wheel cover 1 can fit a steel wheel of 14 inches or 15 inches. It is inappropriate for the same wheel cover 1 to be shared between three or more sized wheels such as the wheel of 13 inches, 14 inches, or 15 inches, because the difference between the largest and smallest sizes is too large, and the latch member has to go beyond the steel wheel such that the wheel cover has to expand to an excessively large size. The inventor has taken this consideration into account to put the first set of latch members 4 and second set of latch members 5 of similar sizes on the same wheel cover 1 and provide the most ideal design. Furthermore, the wheel used for regular motor vehicles has certain limitations; ordinary vehicle only fits two different sizes of wheels, and users can only choose the wheel with two different sizes.

In view of the above description, the present invention can reduce the use of three different molds for manufacturing wheel covers into two. Under the condition that users generally can only choose two different sizes of the wheel cover for installation, the present invention provides a way of manufacturing the wheel cover to fit both choices and meet the user's requirement. The wheel cover of the present invention is still applicable when the size of steel wheels is changed.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. A wheel cover fixture for different sized wheels, comprising of:
a circular disc, disposed on a wheel cover, having a plurality of engraved holes in special shapes; and a latch member disposed on backside of the wheel cover; characterized in that said latch member comprises a first set of latch members and a second set of latch members disposed on a wheel cover; wherein the first set of latch members encloses a first circular area of a first diameter D, the second set of latch members encloses a second circular area of a second diameter d, and the fist diameter D is larger than the second diameter d, such that the wheel cover uses different sets of latch members to enclose areas of different diameters and fit the installation of different sized wheels.

2. A wheel cover fixture for different sized wheels as claimed in claim 1, wherein said first set of latch members comprises a plurality of fixed bases equidistantly disposed on the backside of the wheel cover, and each fixed base has a latch member.

3. A wheel cover fixture for different sized wheels as claimed in claim 2, wherein said fixed base comprises a latch hole for latching the latch member.

4. A wheel cover fixture for different sized wheels as claimed in claim 1, wherein said second latch member comprises a plurality of fixed bases equidistantly disposed on the backside of the wheel cover, and each fixed base has a latch member.

5. A wheel cover fixture for different sized wheels as claimed in claim 4, wherein said fixed base comprises a latch hole for latching the latch member.

6. A wheel cover fixture for different sized wheels as claimed in claim 1, wherein said first set of latch members and second set of latch members respectively have a plurality of fixed bases equidistantly disposed on the backside of the wheel cover; a set of latch members is embedded onto each fixed base of the first set of latch members and the second set of latch members respectively.
